(19) United States
(12) Patent Application Publication
(10) Pub. No.: US 2007/0069998 A1
(43) Pub. Date: Mar. 29, 2007

(54) Method and apparatus for controlling pixel emission

(76) Inventors: W. Edward Naugler JR., Cedar Park, TX (US); Diamoder Reddy, Los Gatos, CA (US)

Correspondence Address: HOWREY LLP, C/O IP DOCKETING DEPARTMENT, 2941 FAIRVIEW PARK DRIVE, SUITE 200, FALLS CHURCH, VA, 22042-2924, US

(21) Appl. No.: 10/515,575

(22) PCT Filed: Jun. 17, 2004
(86) PCT No.: PCT/US04/19526

§ 371 Date: Aug. 10, 2006

Related U.S. Application Data
(63) Continuation-in-part of application No. 10/841,198, filed on May 6, 2004.
(60) Provisional application No. 60/479,342, filed on Jun. 18, 2003.
(60) Provisional application No. 60/523,396, filed on Nov. 19, 2003.
(60) Provisional application No. 60/532,034, filed on Dec. 22, 2003.
(60) Provisional application No. 60/479,342, filed on Jun. 18, 2003.
(60) Provisional application No. 60/523,396, filed on Nov. 19, 2003.
(60) Provisional application No. 60/532,034, filed on Dec. 22, 2003.

(51) Int. Cl. G09G 3/30

(52) U.S. Cl. 345/81

(57) ABSTRACT

Emission from a pixel is received by a sensor. The sensor is coupled to a control unit that receives or determines a value of the sensor's measurable parameter during operation of the pixel. A target value is coupled to the control unit, allowing the control unit to compare the measurable sensor parameter and the target value. The control unit is coupled to a pixel driver operable to alter the emission from the pixel. The pixel driver may vary the emission from the pixel until the measurable sensor parameter indicates that the target value has been achieved. The target value may be determined based on a calibration of the sensor. A plurality of target values may be stored in a look-up table. Passive and active matrix displays may be controlled in accordance with methods and apparatuses of the invention.

### CROSS-REFERENCE TO RELATED APPLICATIONS

The present application claims the benefit of the filing date under 35 U.S.C. §119(e) of U.S. Provisional Application Ser. No. 60/479,342 filed 18 Jun. 2003 entitled “Emission Feedback Stabilized Flat Panel Display”, U.S. Provisional Application Ser. No. 60/523,396 filed 19 Nov. 2003 entitled “Passive Matrix Emission Stabilized Flat Panel Display”, and U.S. Provisional Application Ser. No. 60/532,034, filed 22 Dec. 2003 entitled “Stabilized Flat Panel Display”, all of which are incorporated herein by reference in their entirety.

The present application is a continuation-in-part of U.S. patent application Ser. No. 10/841,198 entitled “Method and Apparatus for Controlling Pixel Emission,” filed 6 May 2004, which application is incorporated herein by reference in its entirety.

### TECHNICAL FIELD

The present invention relates generally to displays, and more particularly, to control of the gray-level or color and brightness of displays and picture elements of such displays.

### BACKGROUND OF THE INVENTION

Flat panel displays typically convert image data into varying voltages fed to an array of picture elements (pixels) causing the pixels to either pass light from a backlight as in a liquid crystal display (LCD), or to emit light as in for example an electroluminescent or organic light emitting diode (OLED) display. The image voltages applied to picture elements (pixels) determine the amount of light from the pixel. Present display designs make no provision for checking that when a voltage is placed on the pixel that the correct amount of light is transmitted or emitted. For example, in the LCD display device, a voltage is placed across the liquid crystal cell, which transmits a certain amount of light from the backlight. LCDs providing color information use red, green, and blue filters. The LCD relies on uniform manufacturing processes to produce pixels close enough in electrical properties that the display has a high degree of uniformity. For some LCD technologies and applications the uniformity over the life of the device is sufficient for the intended application.

In the case of the active matrix OLED display, a voltage is placed on the gate of a power transistor in the pixel, which feeds current to the OLED pixel. The higher the gate voltage, the higher the current and the greater the light emission from the pixel. It is difficult to produce uniform pixels and even if such uniform pixels could be produced it is difficult to maintain uniformity during the lifetime of a display containing an array of such pixels. As a result of manufacturing tolerances, transistor current parameters typically vary from pixel to pixel. Also the amount of light emitted by the OLED material varies depending on the OLED's current-to-light conversion efficiency, the age of the OLED material, the environment to which individual pixels of the OLED-based display are exposed, and other factors. For example, the pixels at an edge of the OLED display may age differently than those in the interior near the center, and pixels that are subject to direct sunlight may age differently than those which are shaded or partially shaded. In an attempt to overcome the uniformity problem in emissive displays, several circuit schemes and methodologies are in use today. One scheme uses a current mirror at the pixel where, instead of image voltages, image currents are used to force a particular current through the power transistor feeding the OLED. Also circuits have been designed which test the power transistor threshold voltage and then add the image voltage to the threshold voltage, therefore, subtracting out the threshold voltage so that variances in threshold voltage do not vary the OLED brightness. These circuit schemes are complex, expensive to produce and have not been entirely satisfactory.

Any display that requires a large number of gray shades requires uniformity greater than one shade of gray. For example, a hundred shades of gray require a display uniformity of 1% in order to use one hundred brightness levels. For a thousand gray levels 0.1% brightness uniformity is desired. Since it is difficult, if not impossible, to have a mass production process that holds 0.1% uniformity in the thin film area, another means of forcing uniformity on the display must be found.

One previous approach was to use certain optical feed back circuits, providing a particular type of feedback from optical diodes or optical transistors in an attempt to provide data on the actual brightness of a pixel's light emission and use the fed back data to cause a storage capacitor to discharge, thus, shutting down the power transistor. This requires a photodiode placed at each pixel as well as a means of reacting to the data supplied by the photodiode. Each pixel must have the discharge circuit. Accordingly, each pixel must include a highly complex circuit. Further, the circuit elements themselves, including the photodiode all introduce variables, which introduce non-uniformity. Further this approach only tends to cause uniformity since bright pixels are shut down faster and dim pixels are left on longer, but no exact brightness level is measured or used as a reference.

A second approach added a blocking transistor to the optical diode that relied on the pixel reaching an equilibrium brightness determined by the pixel brightness, the optical response of the diode, and all the parameters that determine the current supplied by the power transistor during the write time of the image line. However, the equilibrium brightness is determined by all the parameters mentioned above and these parameters can vary from pixel to pixel. Therefore, the attempted correction was not pixel-specific and did not take into account the changes for each pixel over time. Another problem is that the particular feedback circuit and method can set the system into oscillations, which if not damped within the line write time, would leave the actual brightness and voltage undetermined at the point of write time cut off.

Passive displays are addressed one line at a time, so that the line is on only during the address time. For example, if a display has fifty lines and is running at 60 frames per second, the address time is 1/(60*50)=333 microseconds. Most passive displays have only a two level grayscale (on and off, white or black). In a passive display the lines are scanned one at a time. Thus, for a fifty line passive display scanned at 60 frames per second each line is on for only 333 microseconds. Because the scan rate is high the eye does not perceive the lines blinking, but perceives the average light emission over the duration of the frame. This means that in order that the display have a specific perceived brightness, for example 100 cd/m², the average brightness must be multiplied by the number of lines. Therefore, the instantaneous line brightness in the 50 line display is 5000 cd/m². This requires very high instantaneous current levels in the display pixels, that cause accelerated pixel degradation and high power consumption due to the I²x impedance law. The high power consumption and accelerated pixel degradation cause rapid development of non-uniformities.

Further, in conventional passive matrix displays, crisscrossing wires are relied on to address each pixel element. Typical designs require at least two metal layers during fabrication, requiring two masked photolithographic steps. Each photolithographic step is time consuming and costly.

Accordingly, an apparatus, system and method is needed that stabilizes a display but advantageously is not effected by variation in photodiodes or other circuit parameters. The apparatus, system, and method should preferably not allow the system to enter oscillation and should allow the full range of brightness to be used over the life of the display. Further, a passive matrix display is needed advantageously requiring only a single metal layer for addressing the pixels.

### SUMMARY OF THE INVENTION

In an aspect of the present invention, a method for controlling emission to achieve a predetermined emission level is provided. Light emission from the pixel is varied using a pixel driver. Light emission from the pixel is received at a sensor. A measured value of a measurable sensor parameter is obtained responsive to the received light emission. The measured value is coupled to the pixel driver and a control signal is generated for the pixel to maintain constant emission from the light source at the predetermined emission level. The measured value may be compared to a reference value of the measurable sensor parameter, the reference value indicative of the predetermined emission level. The sensor may be calibrated to determine the reference value. In some embodiments, a plurality of reference values are stored in a look-up table for use in controlling emission.

In another aspect of the present invention a controlled pixel system is provided. A sensor having a measurable sensor parameter positioned to receive at least a portion of the radiation emitted from a pixel. A pixel driver is coupled to the pixel, the pixel driver operable to supply a drive signal to the pixel to vary light emission from the pixel. A control unit coupled to the pixel driver and the sensor, the control unit operable to determine, based on a measured value of the measurable sensor parameter, the predetermined emission level is attained and develop a control signal for the pixel driver to maintain constant light emission at the predetermined emission level.

According to an aspect of the present invention, a method of controlling an array of pixels in an active matrix display to a predetermined emission level is provided. The pixels are arranged in a plurality of rows and a plurality of columns, each pixel having an active matrix element. The method makes use of a plurality of sensors each having a measurable sensor parameter and at least one pixel driver. Light emission is varied from a plurality of pixels in a first row using the pixel driver and the active matrix elements in the pixels. Light emission is received from the pixels at the sensors and a measured value of the measurable sensor parameter is obtained responsive to the received light emission. For each of the plurality of pixels, a control signal is generated for the pixel to maintain constant emission from the light source at the predetermined emission level.

According to an aspect of the present invention, a method of controlling light emission to a predetermined emission level in a passive matrix display is provided. Light emission from a plurality of pixels in a first row is varied using column pixel drivers. Light emission from the plurality of pixels in the first row is monitored by monitoring an actual value of the measurable sensor parameter of each of a plurality of sensors, each of the plurality of sensors positioned to receive at least a portion of the light emission from one of the plurality of pixels in the first row. The actual value of the measurable sensor parameter of each of the plurality of pixels in the first row is coupled to the pixel driver. A control signal is generated for the plurality of pixels in the first row to maintain constant emission at the predetermined emission level.

In another aspect, an apparatus for controlling a passive matrix display is provided. A sensor array arranged in a plurality of rows and a plurality of columns is provided, each sensor having a measurable sensor parameter and positioned to receive at least a portion of the radiation emitted from at least one pixel. A row selector is coupled to the sensor array and coupleable to the display. The row selector is operable to select at least one of the plurality of rows. A plurality of comparators are each coupled to a plurality of the sensors located in a common column and a reference signal indicative of a target value of the measurable sensor parameter for a pixel in the selected row, the comparator operable to compare a measured value of the sensor parameter with the reference signal and generate a control signal. A plurality of pixel drivers are each coupled to pixels located in a common column, each of the plurality of pixel rivers coupled to a selected one of the plurality of comparators and operable to receive the control signal and maintain the amount of radiation emitted from the pixels.

A method for aligning a dark shield with a sensor and a plurality of contacts is provided according to another aspect of the present invention. The dark shield is formed on a first surface of a transparent substrate having a second surface opposite the first surface. An insulating material is formed over the dark shield. Material for the sensor is deposited over the insulating material and light source shield. Material for electrical contacts is deposited over the material for the sensor. The substrate is coated with negative photoresist above the material for the electrical contacts. The negative photoresist is exposed with a light source positioned to pass light through the transparent substrate, such that a portion of the light is blocked by the dark shield, and developed. The material for the electrical contacts is etched through the developed negative photoresist, such that a plurality of electrical contacts are formed over the material for the sensor, and the plurality of electrical contacts are aligned with the dark shield. In this manner, a passive matrix display may be provided that requires only a single metal layer for the connections to the sensor array. In the case of using an opaque conducting material such as chrome or aluminum a method is provided using a rear positive photoresist expose causing hardened photoresist to be located over the dark shield to define the sensor material in the geometrical form of the dark shield. The metal layer is then deposited and defined using methods well known in the industry.

A method is further provided where sensors in a column are connected by parallel lines of metal wherein the sensors form the ‘rungs’ of a ladder-like shape between the contacting conductive line; therefore, just one metal layer is required rather than two metal layers as in orthogonal connecting conductive lines.

### BRIEF DESCRIPTION OF THE DRAWINGS

FIG. 1 is a schematic illustration of an apparatus according to an embodiment of the present invention.

FIG. 2 is a schematic illustration of an implementation of the apparatus in FIG. 1, according to an embodiment of the present invention.

FIG. 3A is a schematic illustration of an actively addressed display according to an embodiment of the present invention.

FIG. 3B is a schematic illustration of an actively addressed display including components providing a reference signal, according to an embodiment of the present invention.

FIG. 3C is a schematic illustration of an actively addressed display for use with periodic calibration, according to an embodiment of the present invention.

FIG. 4 is a schematic illustration of an array of sensors, according to an embodiment of the present invention.

FIG. 5 is a schematic illustration of a passively-addressed display according to an embodiment of the present invention.

FIG. 6 is an illustration of a passively-addressed display according to an embodiment of the present invention.

FIG. 7 is a top-down view of four pixels from the display embodiment shown in FIG. 6 according to an embodiment of the present invention.

FIG. 8 is a cross-section view of the area marked ‘A’ in FIG. 7, according to an embodiment of the present invention.

FIG. 9 is an illustration of a display according to an embodiment of the present invention.

FIG. 10 is an illustration of a display according to an embodiment of the present invention.

### DETAILED DESCRIPTION OF PREFERRED EMBODIMENTS

Embodiments of the present invention provide systems, methods, circuits, and apparatuses for controlling emission from a pixel. The emission source may be generally any source known in the art that produces radiation in response to a supplied voltage—including light emitting diodes and organic light emitting diodes at any wavelength including white organic light emitting diodes. In some embodiments, such as an LCD display, the light source is a backlight and light emission from the pixel is controlled by varying the amount of light from the backlight passed through the pixel. Other light sources may be used including electroluminescent cells, inorganic light emitting diodes, vacuum florescent displays, field emission displays and plasma displays. While radiation (or illumination) sources intended to display graphics, images, text, or other data or information for human viewing will primarily be in the visual wavelengths (generally about 400-700 nanometers) it is understood that the invention applies as well to shorter and longer wavelengths as well such as for example, but not limited to ultraviolet and infrared radiation.

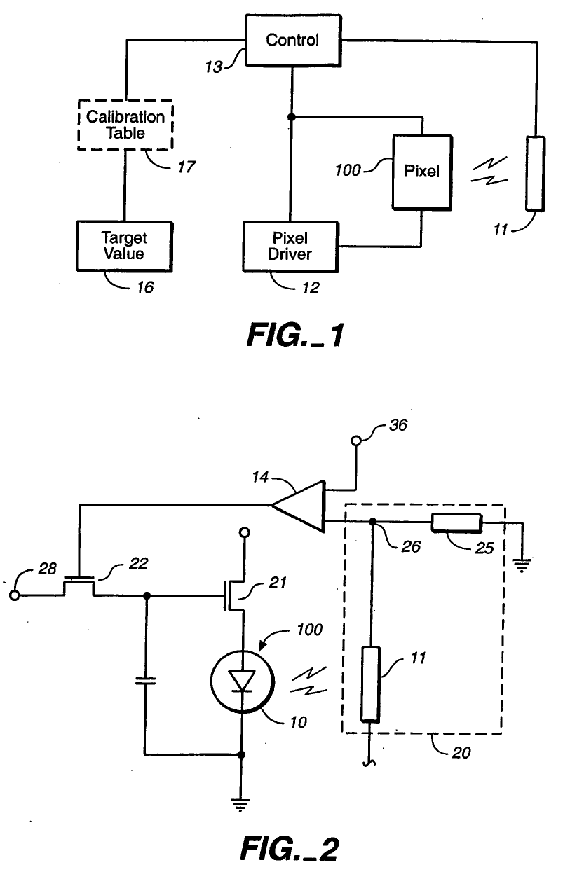

Emission from a pixel 100 is received by a sensor 11, as shown in FIG. 1. The sensor 11 can be any sensor suitable for receiving radiation from the pixel 100. The sensor 11 may be a photo-sensitive resistor. Other radiation- or light-sensitive sensors may also or alternatively be used including, but not limited to, optical diodes and/or optical transistors. The sensor 11 has at least one measurable parameter where the value of the measurable parameter is indicative of the radiation emission from the pixel 100. For example, the sensor 11 may be a photo-sensitive resistor whose resistance varies with the incident radiation level. The radiation or optically sensitive material used to form the photo-sensitive resistor may be any material that changes one or more electrical properties according to the intensity of radiation (such as the intensity or brightness or visible light) falling or impinging on the surface of the material. Such materials include but are not limited to amorphous silicon (a-Si), cadmium selenide (CdSe), silicon (Si), and Selenium (Se) for example.

The sensor 11 is coupled to a control unit 13, such that the control unit 13 receives or determines a value of the sensor's measurable parameter during operation of the pixel 100. A target value 16 is also coupled to the control unit 13, allowing the control unit to compare the measurable sensor parameter and the target value 16. The control unit 13 generates a control signal based on this comparison to influence light emission from the pixel 100. The control unit 13 may be implemented in hardware, software, or a combination thereof. In one embodiment, the control unit 13 is implemented as a voltage comparator. Other comparison circuitry or software may also be used.

The target value 16 is representative of the desired emission of the pixel 100 and may take any form including but not limited to, a current value, a voltage value, a capacitance value, or a resistance value, suitable for comparison with the measurable sensor parameter.

The control unit 13 is coupled to a pixel driver 12. The pixel driver 12 is operable to develop a drive signal for the pixel 100 to determine the light emission from the pixel 100. The pixel driver 12 may include any hardware, software, firmware, or combinations thereof suitable for providing a drive signal to the pixel 100. The pixel driver 12 in some embodiments is located outside of the area of the pixel 100. That is, the pixel 100 may be formed on a display substrate, described further below. The pixel driver 12 is preferably located outside of the display area. The pixel driver 12 may be integrated with the display substrate, or may be separate from the display substrate. In some embodiments, portions of the pixel driver 12 are contained within the pixel 100. Embodiments of the present invention provide for coupling information from a sensor regarding light emission from the pixel 100 to the pixel driver 12.

In one embodiment, the pixel driver 12 varies the light emission from the pixel 100 until the measurable sensor parameter indicates that the target value 16 has been achieved. This may indicate that the values match to within a specified degree of certainty, or that the values have attained some predetermined relationship. The control unit 13 then couples a control signal to the pixel driver 12 to stop the variation of the light emission and maintain the light emission level. Accordingly, variations in the pixel 100 are accounted for, as the control unit 13 bases its comparison on the measurable sensor parameter of the sensor 11.

In some embodiments, variations in the sensor 11 may further optionally but advantageously be accounted for through use of a calibration table 17 coupled to the emission control 13 and the target value 16. The sensor 11 is calibrated such that one or more values of the measurable parameter are known for predetermined light intensity levels. Accordingly, in an embodiment where the sensor 11 is a photo-sensitive resistor, the resistance of the sensor is determined at one or more light levels of interest. Calibration procedures are described further below. The calibrated values 17 may be stored, for example, in a look-up table or other format in a memory or other storage device. The target value 16 is coupled to the calibration table 17 and a calibrated value is provided to the control unit 13 for comparison with the measurable sensor parameter of the sensor 11.

Based on the comparison, the control unit 13 couples a control signal to the pixel driver 12 that is varying emission of the pixel 100. In this manner, emission of the pixel 100 is controlled to a particular emission or brightness level, based on a known target value or calibration value of the sensor 11. Variations in fabrication or operation of the sensor 11 may be accounted for during the calibration process of the sensor, described further below. The operation of the light or radiation source 10 in pixel 100 is controlled in that the radiation output is monitored and held at a level based on a target value of the measured sensor output.

While components of an apparatus according to the invention are shown in FIG. 1, it is to be understood that the illustrated components may be implemented in a variety of ways. FIG. 2 illustrates one embodiment of an apparatus according to an embodiment of the present invention. In the embodiment shown in FIG. 2, the pixel 100 includes a light source 10 positioned to illuminate the sensor 11. The sensor 11 is a photo-sensitive resistor as shown in FIG. 2, but may also be a photo-sensitive diode or transistor, and may be implemented as shown in FIG. 2 in a voltage divider 20 with a second resistor 25. Accordingly, a voltage at node 26 changes as the brightness level of the radiation source 10 changes. The control unit 13 is implemented as a voltage comparator 14 coupled to the node 26 and the target value 16 at node 36. The target value 16 may be simply a target value or may be a target value adjusted by a calibration table, as described above. The target value 16 may be supplied by a memory or look-up table and provided to node 36 of the comparator 14. A power transistor 21 is coupled to the light source 10. The power transistor 21 regulates the current through the light source 10. The gate of the power transistor 21 is coupled to a data transistor 22. The data transistor 22 forms part of the pixel driver 12. The gate of the data transistor 22 is coupled to an output of the voltage comparator 14.

In the embodiment shown in FIG. 2, the comparator 14 is configured to output a first signal to transistor 22, which turns on transistor 22 when the node 26 is at a lower voltage potential than the node 36. The comparator 14 is configured to output a second signal to transistor 22, which turns transistor 22 off when the voltage potential at node 26 is equal to or greater than the node 36. As a continuously varying voltage, such as a voltage ramp, is applied on the node 28, current through the light emitting diode 10 ramps up, increasing the light emission from the diode 10 and the radiation incident on the sensor 11, modifying the voltage at the node 26. When the emission of the diode 10 reaches the desired value, the voltage at the node 26 becomes equal to the voltage at the node 36, and the comparator 14 outputs the second signal, to transistor 22, which turns transistor 22 off, thus, stopping the increase of current through the diode 10. Storage capacitor 32 stores the voltage on the gate of power transistor 21, thus, maintaining the emission level at the desired brightness level.

In this manner, control is provided generally by varying the light emission from the light source 10 and halting the variation of the light emission when the measured sensor parameter indicates the target emission level has been attained. The light emission may be varied in any manner over time—including, for example, increasing or decreasing ramp, sinusoidal variations, square-wave variations, increasing or decreasing steps, or substantially any other variation with time. In some embodiments, the light emission is varied by turning the light source on and off, once or a plurality of times. Embodiments incorporating a ramp voltage (linear or nonlinear) are conveniently implemented and in some embodiments the ramp voltage can be generated by supplying a square wave voltage (a step voltage) where the voltage ramp is caused by the rise time due to the pixel circuitry's parasitic capacitances and resistances coupled with the storage capacitor and the gate capacitance of the power TFT.

The variation is halted when the value of the measurable sensor parameter indicates that the target emission level has been reached. Embodiments of the present invention accordingly control a light source using a system that does not have a settling time dependent on a particular circuit loop gain, as has been the case in conventional systems utilizing feedback circuits.

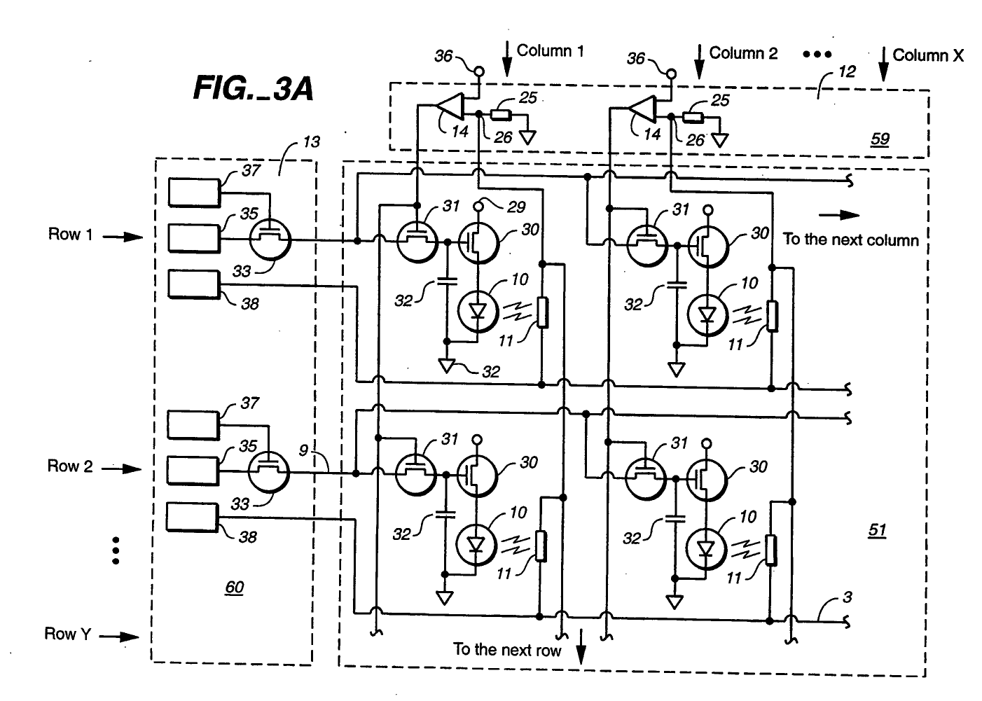

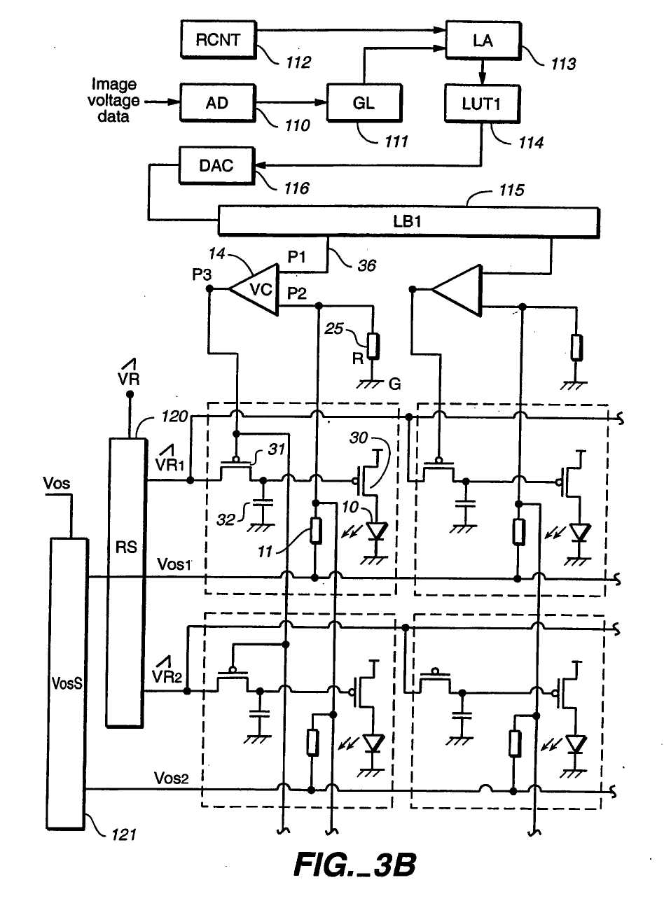

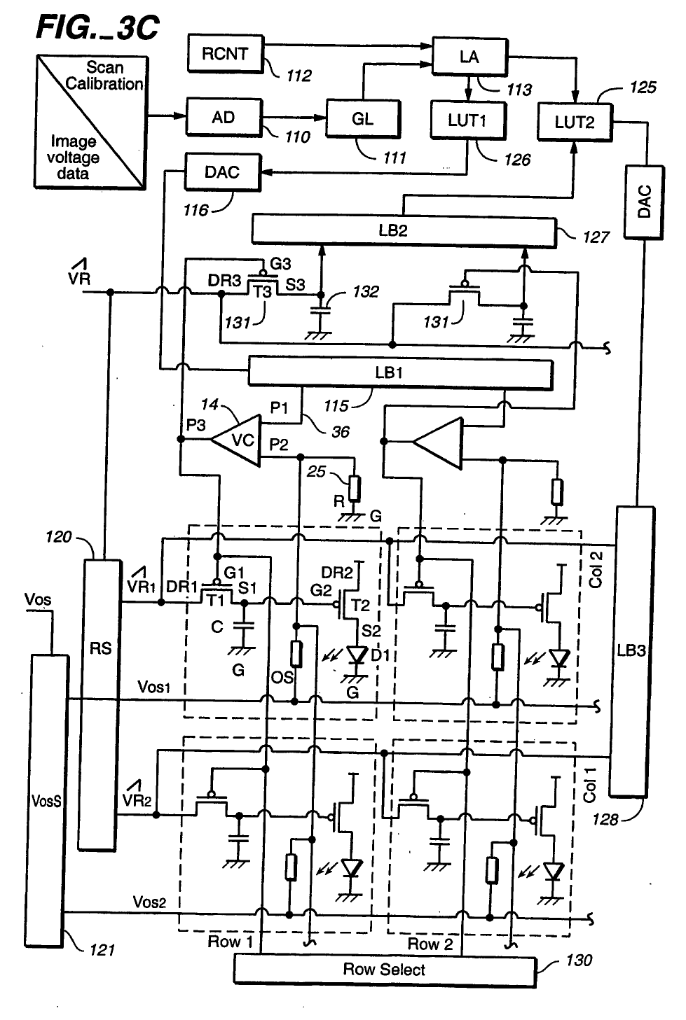

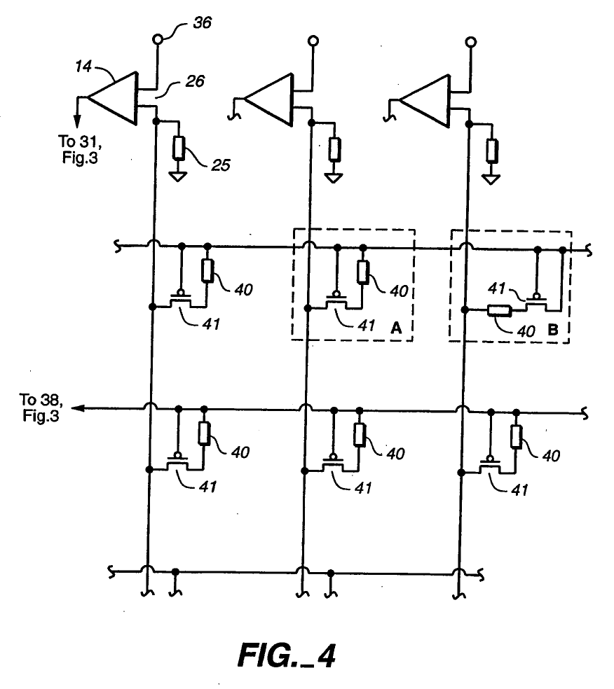

Methods and apparatuses for stabilizing a light source according to embodiments of the invention may advantageously be used to control or stabilize one or a plurality of light sources in an electronic display. Any type of display using voltage or current to control pixel brightness may be used with these techniques. For example, one or an array of light emitting diodes, including for example organic light emitting diodes, where each light emitting diode represents a light source for a pixel in a display, may be controlled according to embodiments of the invention. One embodiment of a controlled array of light emitting diodes is illustrated in FIG. 3A. Although FIG. 3A depicts an exemplary embodiment, those skilled in the art will recognize that other design configurations may be employed to achieve the control mechanisms described. The embodiment shown in FIG. 3A illustrates actively addressed light emitting diodes. An array of the sensors 11 are positioned to capture radiation from an array of organic light emitting diodes OLEDs 10 or other light emitting elements, or any other light source, as described above. An array of active matrix (AM) pixel transistors 30, and 31, and storage capacitors 32 are coupled to the light sources 10 such that one pair of active matrix pixel transistors 30 and 31 drive each light source 10, along with a storage capacitor 32.

The light sources 10 are arranged in an array format shown in FIG. 3A where columns are labeled 1, 2, to x and rows are labeled 1, 2, to y. Although an orthogonal row-and-column layout is shown in FIG. 3A with an equal number of light sources in each row, and an equal number of light sources in each column, it is to be understood that the array of light sources may not be so ordered in other embodiments. There may be any number of rows and columns, and in some embodiments the rows and columns may not contain an equal number of light sources, and in some embodiments the rows and columns may not be orthogonal or may not lie in straight lines. In some embodiments, there may only be a single row or single column, or a sparsely populated array where not every row and column contains a pixel. Non-array configurations may also or alternately be implemented.

A plurality of sensors 11 are coupled to the voltage comparator 14. As shown in FIG. 3A, one voltage comparator 14 is coupled to all the sensors 11 in a single column (numbered 1, 2, to x). In some embodiments, a plurality of voltage comparators 14 may be provided for the sensors 11 in a column. A voltage ramp circuit 35 is provided coupled to the active matrix pixel transistors 31 in each row, as shown in FIG. 3A. Each light source with its AM elements 30, 31, and 32, and optical detector 11 is associated with a unique combination of voltage comparator 14 and ramp circuitry 35. That is, each light source 10 is identified by a unique row- and column-address, as shown in FIG. 3A.

The sensors 11 may be simple passive optical resistors for a linear array, but if more than a few rows are desired then an active array may be advantageous to reduce cross-talk among the sensors. Accordingly, one or more of the optical detectors 11 may include an optically sensitive resistor 40 coupled to a transistor 41, or a different switch, as shown in FIG. 4. The circuit of the sensor array can vary according to ways known in the art. Boxes A and B in FIG. 4 illustrate two methods of implementing the optical resistor 11 with the transistor 45.

The optical detectors are calibrated to determine the relationship between the measurable parameter—such as voltage across an optical resistor—and incident radiation. In this manner, the desired brightness level of each pixel may be correlated to a value of the measurable sensor parameter.

During operation, image data are written to a first row. A row is selected by applying voltage from voltage generator 37 to the gate of TFT 33 in the row being selected. Meanwhile all the TFT 33s in the other rows remain in the off state. An image datum is indicative of the desired brightness of the pixel and represents the value of the measurable sensor parameter needed to attain the desired brightness. In the embodiment shown in FIG. 3A, the image data are coupled to each node 36. Typically as each line is written to, any pre-existing voltage on the storage capacitor 32 is first erased by placing a voltage on the gates of transistors 31 and 33 and grounding ramp generator 35. Accordingly, voltage levels representing the desired brightness of each pixel in row one are down loaded to pin 36 of each voltage comparator 14 for a plurality of the columns in the display from 1, 2, . . . , x. In the embodiment shown in FIG. 3A, the voltage comparators 14 are designed to output a voltage that turns on the transistors 31 (+10 V in one embodiment) when the voltage on pin 26 is less than the voltage on pin 36. Therefore, the voltage comparator 14 delivers a turn-on voltage to each of the gates of the transistors 31. A voltage source 37 delivers a turn-off voltage to the gates of transistors 33, accordingly light emission does not begin through the light sources while the transistors 33 remain off.

When the voltage source 37 in row one places a turn-on voltage on the gate of the transistor 33 for row one, the ramp generator 35 begins to ramp the voltage applied to the drain of the transistor 33 in row one, and thus, the drain of the transistor 31, and thus, the voltage begins to rise on the storage capacitors 32 in row one and the gates of the transistors 30, in the first row only; and the voltage source 38 places a reference voltage (for example, +10 volts) on the voltage divider including the sensors 11 in row one. Although this description focused on the method during writing image data to row one, it is to be understood that any row may be written to using methods described herein.

Accordingly, voltage begins to ramp up on the gates of the power transistors 30 in row one, causing currents to flow through the light sources 10 in row one. Current also begins to flow through the sensors 11 and resistors 25 in row one. This causes the voltages to rise on pins 26 of the voltage comparators 14. As long as the resistance of the optical sensors 11 remains stable the voltages on pins 26, of voltage comparators 14 is stable and below the data voltages placed on pins 36 of the voltage comparators 14. Since, however, the OLEDs are increasing their light emission due to the ramp voltage from ramp generator 35 for row one, the resistance of optical detectors 11 in row one are decreasing according to the brightness of the illumination.

Due to the decrease in resistance of the optical sensors 11 in row one, the voltages on pins 26 of the voltage comparators 14 are increasing due to the higher current flows through resistors 25. The brightness of the pixels in row one determines the voltages on pins 26. When the voltage on pin 26 equals the data voltage placed on pin 36 the output voltage of the voltage comparator 14 switches from a turn-on voltage for the transistor 31 to a turn-off voltage for the transistor 31 (+10 volts to −10 volts, for example). At this point the brightness of each pixel in row one is determined by the data voltage placed on pins 36 of each of the voltage comparators 14.

When the voltage output of each of the voltage comparators 14 switches to a turn-off voltage (−10 Volts, in one embodiment) the gates of the transistors 21 are placed in the off condition and the ramp generator 35 is no longer able to increase the voltage on storage capacitor 32 and power transistor 30 thus, freezing the brightness of the pixel. The time allowed for all the pixels to reach the brightness determined by the data voltages placed on pins 30 of voltage comparators 25 is called the line scan time and is determined by the number of frames per second and the number of lines. For example, a frame rate of 60 fps takes 16.7 ms for each frame. If there are 1000 rows (lines), the line scan time is 16.7 microseconds (μs). Therefore, the display circuitry is advantageously designed so that the maximum brightness allowed (the top gray shade) is reached in less than 16.7 μs in one embodiment. Slower circuitry may also be used by altering the frame rate or number of rows. Other trade-offs in speed and accuracy may be made.

Once row one is completed, the row one light sources 10 are at their desired brightness with the desired gate voltage placed on the power transistors 30 and held by the storage capacitors 32. Voltage source 37 for row one is now switched to place the off voltage on the gate of transistors 33 for row one. Simultaneously, the ramp generator 35 for row one is optionally switched off and the voltage source 38 is switched to an off value, turning off the sensors 11 in row one. This completes the locking of the voltages placed on the gates and storage capacitors in row one regardless of the gate status of the transistors 31. A second row may now be controlled in an analogous manner to row one.

The brightness of each pixel accordingly depends on knowing or estimating the resistances of the optical resistor 11 and the ground resistor 25 coupled with the image data voltages. All variations in the transistors 31 and 30 do not influence the control, nor do the variations in the emission output versus current characteristics of the light sources 10, or the aging history of the light sources 10. Furthermore, the optical sensing circuit also gives information on the ambient light conditions, which can be used to adjust the overall brightness of the light source array to compensate for changing light conditions. If, for example, a shadow falls on one or more of the light sources 10 those sources in the shadow are dimmed, maintaining a uniform appearance of the display.

FIG. 3B illustrates an embodiment of a system providing the reference voltage for the node 36 in FIG. 3A. Image data may be provided to an analog to digital converter (A/D) 110. The digital values may then be coupled to an optional grayscale level calculator 111 that determines a number of the grayscale level corresponding to the digital image data. In some embodiments, the grayscale level calculator 111 is not needed, and the output of the A/D converter 110 is indicative of the grayscale level. A row and column tracker unit 112 couples a line number and column number to a calibration look-up table addresser 113. The grayscale level calculator 111 further couples the grayscale level to the calibration look-up table addresser 113. The look-up table addresser 113 is coupled to a calibration lookup table 114 that includes calibration data. When the address is coupled to the look-up table 114, a reference number stored at the address is converted to an analog voltage by DAC 116 and is coupled to a line buffer 115 and then coupled to one or a plurality of reference pins on the voltage comparators 14 for one or a plurality of columns. In this manner, image data for a selected row is coupled to the voltage comparators. A voltage ramp line selector 120 is provided coupled to the pixels in each row. The row selector 120 selects a row and couples a voltage ramp to the pixels in the selected row. The voltage line selector 121 couples a voltage signal to the sensors in the selected row.

The embodiment shown in FIG. 3B may be used during “real-time”, or continuous, control of a display, where image data are supplied to the pixels and the pixel brightness is continuously controlled to the image data value. In some embodiments, it may be advantageous to provide only periodic, or discrete, updating of the pixel brightness level. In such a periodic update system, image data from a lookup table is placed directly on the gate of the power transistor through the channel of the data transistor. Periodically, the display is scanned using the comparators to interrogate the pixels and adjust the signal supplied to the power transistor.

An embodiment of a controlled display that may be periodically updated or controlled is shown in FIG. 3C. A drive signal to be applied to each pixel is stored in a look-up table 125. Drive signals are supplied to each pixel during operation using line buffer 128 and row selector 130. The row selector 130 selects a row as the drive signal for a pixel in the selected row is coupled from the line buffer 128. Initial values stored in the look-up table 125 may generally be determined through any suitable method. During operation of the display, a calibration may take place at generally any interval—periodically or at random intervals, including only once. During a calibration phase, calibration data is supplied by look-up table 126 and provided to the comparators 14 using the line buffer 115, as described above with regard to FIG. 3B. The row selector 120 outputs a varying signal, such as a ramp to the selected row as well as to calibration transistors 131. As described above, comparators 14 are provided to halt the varying signal and maintain constant emission once the pixel's emission reaches the calibration level supplied to the comparator. In the embodiment shown in FIG. 3C, the value of the drive signal during constant emission is further stored in the line buffer 127 through the calibration transistors 131 and capacitors 132. During further operation of the display, calibrated image data is passed from line buffer 127 to the look-up table 125. The calibration procedure may occur at any frequency, or at random—including but not limited to once an hour, once a day, once a year, once per owner, once per environment or application. Alternatively, the calibration procedure could occur at the command of a user or administrator of the display.

The embodiment of a display shown in FIG. 3C may be integrated—that is components used during the calibration phase and during operation of the display may be packaged together. In some embodiments, components used during the calibration (such as the comparators 14, the row selector 120, the calibration transistors 131, and/or the line buffers 127 and 115) are brought into communication with the pixels during calibration mode only, and are not coupled to the pixels when calibration is not taking place. The calibration components may be provided, for example, on one or a plurality of additional integrated circuits.

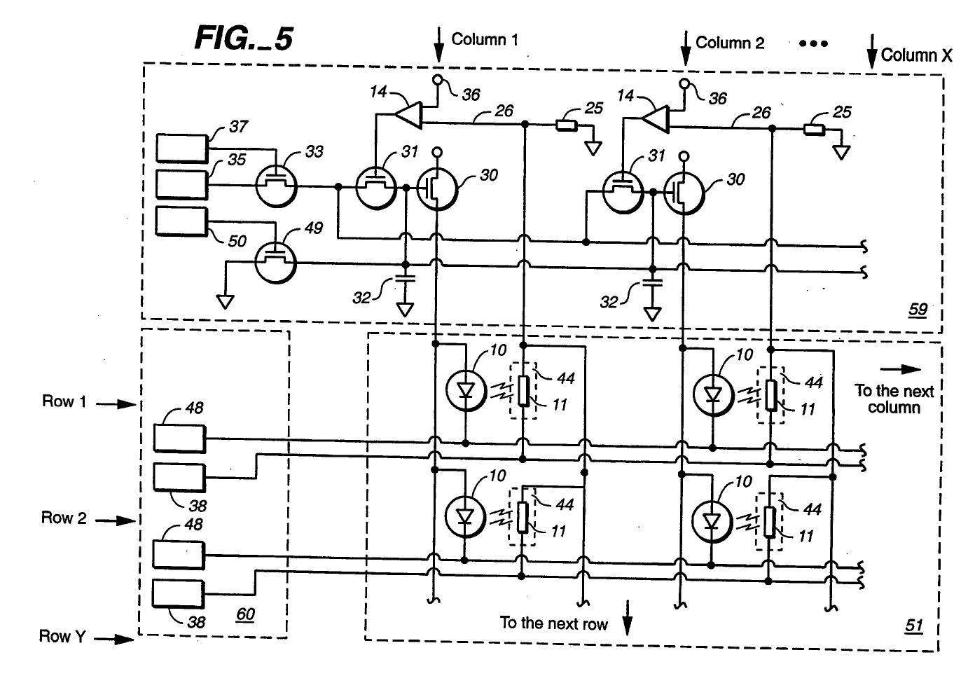

FIG. 5 illustrates an embodiment of a passively addressed array of light emitting diodes according to an embodiment of the present invention. An array of the sensors 11 are positioned to capture radiation from an array of organic light emitting diodes OLEDs 10 or other organic light emitting elements, or any other light source, as described above. The light sources 10 are arranged in an array format shown in FIG. 5 where columns are labeled 1, 2, to x and rows are labeled 1, 2, to y. Although an orthogonal row-and-column layout is shown in FIG. 5 with an equal number of light sources in each row, and an equal number of light sources in each column, it is to be understood that the array of light sources may not be so ordered in other embodiments. There may be any number of rows and columns, and in some embodiments the rows and columns may not contain an equal number of light sources, and in some embodiments the rows and columns may not be orthogonal or may not lie in straight lines. In some embodiments, there may only be a single row or single column, or a sparsely populated array where not every row and column contains a pixel.

A plurality of sensors 11 are coupled to the voltage comparator 14. As shown in FIG. 5, one voltage comparator 14 is coupled to all the sensors 11 in a single column (numbered 1, 2, to x). In some embodiments, a plurality of voltage comparators 14 may be provided for the sensors 11 in a column. A power transistor 30, an addressing transistor 31 and a storage capacitor 32 are provided coupled to the comparator 14 for each column, as shown in FIG. 5. A voltage ramp circuit 35 is provided coupled to the data transistors 31 in each column, as shown in FIG. 5. A ground selector 48 is coupled to the optical diodes 10 in a row. The ground selector 48 grounds the diode when desired. A voltage generator 38 is provided, one for each row, coupled to the optical sensors 11 in the row. The voltage generator 38 supplied a voltage to the optical resistors in the row.

Each light source and optical detector 11 is associated with a unique combination of voltage comparator 14 and ground selector 48 and voltage source 38. That is, each light source 10 is identified by a unique row- and column-address, as shown in FIG. 5. The optical detectors may be calibrated to determine the relationship between the measurable parameter—such as voltage across an optical resistor—and incident radiation. In this manner, the desired brightness level of each pixel may be correlated to a value of the measurable sensor parameter.

During operation, image data are written to a first row. An image datum is indicative of the desired brightness of the pixel and represents the value of the measurable sensor parameter needed to attain the desired brightness. In the embodiment shown in FIG. 5, the image data are coupled to each node 36. Typically as each line is written to, any pre-existing voltage on the storage capacitor 32 is first erased by voltage generator 50 placing a voltage on the gate of transistor 49, thus, grounding capacitor 32. Accordingly, voltage levels representing the desired brightness of each pixel in row one are down loaded to pin 36 of each voltage comparator 14 for a plurality of the columns in the display from 1, 2, . . . , x. In the embodiment shown in FIG. 5, the voltage comparators 14 are designed to output a voltage that turns on the transistors 31 (+10 V in one embodiment) when the voltage on pin 26 is less than the voltage on pin 36. Therefore, the voltage comparator 14 delivers a turn-on voltage to each of the gates of the transistors 31. A voltage source 37 delivers a turn-off voltage to the gates of transistors 33, accordingly light emission does not begin through the light sources while the transistors 33 remain off.

When the voltage source 37 places a turn-on voltage on the gates of the transistors 33, the ramp generator 35 begins to ramp the voltage applied to the drain of the transistor 33, and thus, the drain of the transistor 31, and thus, the voltage begins to rise on the storage capacitors 32 and the gates of the transistors 30.

The voltage source 38 places a voltage on the optical sensors 11 in the selected row and the ground switch 48 ground the optical diodes in the selected row. Accordingly, the optical diodes in the selected row begin to emit light, while the optical diodes in other rows may not emit light. Although this description focused on the method during writing image data to row one, it is to be understood that any row may be written to, or selected, using methods described herein.

Accordingly, as the light emitting diodes in the selected row emit light, current begins to flow through the sensors 11 in the selected row. This causes the voltages to rise on pins 26 of the voltage comparators 14. As long as the resistance of the optical sensors 11 remains stable the voltages on pins 26, of voltage comparators 14 is stable and below the data voltages placed on pins 36 of the voltage comparators 14. Since, however, the OLEDs are increasing their light emission due to the ramp voltage from ramp generator 35 for the selected row, the resistance of optical detectors 11 in the selected row are decreasing according to the brightness of the illumination.

Due to the decrease in resistance of the optical sensors 11 in the selected row, the voltages on pins 26 of the voltage comparators 14 are increasing due to the higher current flows through resistors 25. The brightness of the pixels in the selected row determines the voltages on pins 26. When the voltage on pin 26 equals the data voltage placed on pin 36 the output voltage of the voltage comparator 14 switches from a turn-on voltage for the transistor 31 to a turn-off voltage for the transistor 31 (+10 volts to −10 volts, for example). Although in some embodiments the comparator is designed to switch an output signal from a turn-on to a turn-off voltage when the voltage on the input pins are equal, the comparator 14 may be designed to switch the output signal when the input pins satisfy substantially any relationship with one another, based on the particular circuit configuration used to implement embodiments of the invention. At this point, the brightness of each pixel in the selected row is determined by the data voltage placed on pins 36 of each of the voltage comparators 14.

When the voltage output of each of the voltage comparators 14 switches to a turn-off voltage (−10 Volts, in one embodiment) the gates of the transistors 31 are placed in the off condition and the ramp generator 35 is no longer able to increase the voltage on storage capacitor 32 and power transistor 30 thus, freezing the brightness of the pixel. The time allowed for all the pixels to reach the brightness determined by the data voltages placed on pins 30 of voltage comparators 25 is called the line scan time and is determined by the number of frames per second and the number of lines. For example, a frame rate of 60 fps takes 16.7 ms for each frame. If there are 100 rows (lines), the line scan time is 167 microseconds (μs). Therefore, the display circuitry is advantageously designed so that the maximum brightness allowed (the top gray shade) is reached in less than 167 μs in one embodiment. Slower circuitry may also be used by altering the frame rate or number of rows. Other trade-offs in speed and accuracy may be made.

Once the selected row is completed, the pixels in the selected row are at the desired brightness and held by storage capacitors 32 for the address time. In a passive display, the image values placed on the pins 36 will typically be either a dark state voltage or a light state voltage (on or off). For those pixels that are off in the selected row, the data voltage on the pin 36 is lower than the dark state voltage. To calculate the dark state voltage, the dark state resistance of the photo resistors 11 may be measured and with the resistance of the voltage divider resistor 25, the voltage at node 26 may be calculated when a known voltage is applied to the photo resistor 11. The selected row will remain on for the duration of the address time. In a 50 line display running at 60 frames per second, the maximum address time is 333 microseconds. For an automotive display, for example, the voltages and calibration of the optical resistors 11 represent the desired brightness of the on pixels in the brightest ambient light condition expected in the vehicle. It is at this brightness level that the voltage data is taken for each photo resistor 11 in the display.

Once row one is completed, the row one light sources 10 are at their desired brightness with the desired gate voltage placed on the power transistors 30 and held by the storage capacitors 32. A second row, and further subsequent rows, may now be controlled in an analogous manner to the first selected row.

While it is expected that each photo resistor 11 would exhibit the same voltage at the same brightness, in practice, there may be some sensor-to-sensor variation. Accordingly, calibration voltages may be stored in a look-up table coupled to the node 36 to adjust incoming image data according to the sensors 11.

The voltage placed on the voltage source 38 may be used as a brightness control. By increasing the voltage on the voltage source 38, the voltage at the input node 26 of the comparators 14 is also increased. This adjusts the overall brightness of the pixels in the selected row.

The brightness of each pixel accordingly depends on knowing or estimating the resistances of the optical resistor 11 and the ground resistor 25 coupled with the image data voltages. All variations in the transistors 31 and 30 do not influence the control, nor do the variations in the emission output versus current characteristics of the light sources 10, or the aging history of the light sources 10. Furthermore, the optical sensing circuit also gives information on the ambient light conditions, which can be used to adjust the overall brightness of the light source array to compensate for changing light conditions. If, for example, a shadow falls on one or more of the light sources 10 those sources in the shadow are dimmed, maintaining a uniform appearance of the display.

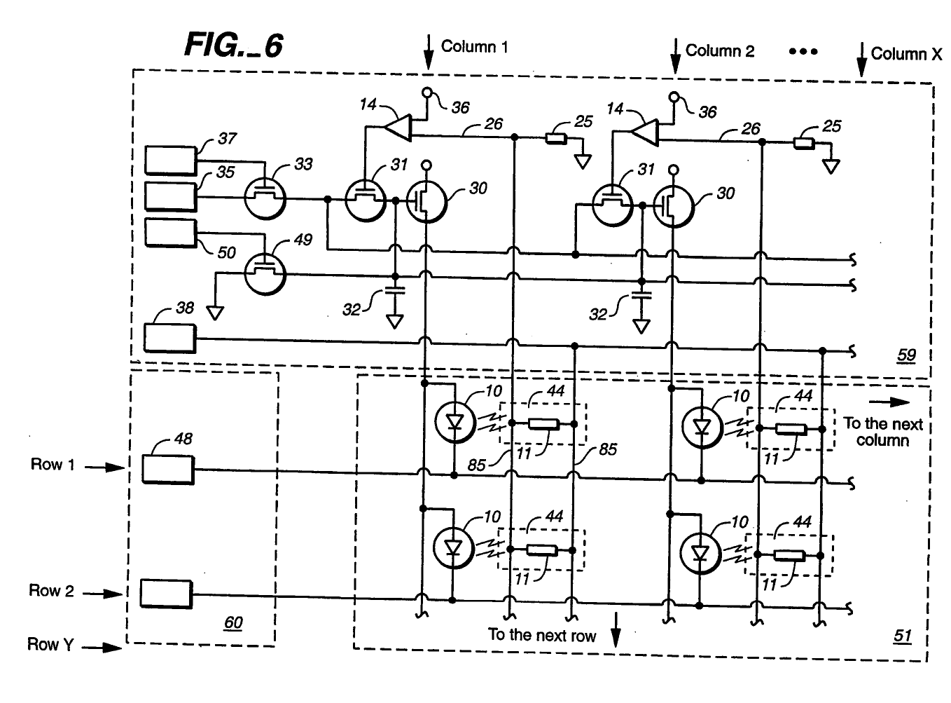

The embodiments of column-and-row addressing shown in FIG. 5 may use more than one layer of conductive material in implementation. That is, two metal layers may be necessary, with an insulator positioned between the layers, as is known in the art, to provide column-and-row addressing schemes where two conductive lines may pass over one another but should not electrically connect to each other. As known in the art, the plurality of conductive layers is typically implemented using a plurality of masks and fabrication steps. The requirement of a plurality of masks and fabrication steps complicates the fabrication of the array. Accordingly, the array is advantageously fabricated using only a single conductive layer mask and layer. One embodiment of a column-and-row addressable display using only a single conductive layer to form the column-and-row addressing lines is shown in FIG. 6.

Passive display 51 is column driven by a column integrated circuit 59 and row driven by a row selector integrated circuit 60, as shown in FIG. 6. The pixel circuitry and driving circuitry shown in FIG. 6 operates in an analogous fashion to the passive display described above with regard to FIG. 5. However, in the embodiment shown in FIG. 6, the voltage generator 38 is located in column integrated circuit 59 and not in row selector 60 as in the embodiment shown in FIG. 5. Accordingly, the embodiment shown in FIG. 6 provides a single voltage generator 38 coupled to each sensor 11 in each row, rather than a voltage generator 38 for each row. Additionally, in the embodiment shown in FIG. 6, the sensors 11 are positioned between sensor connect lines 85, in a ‘ladder-like’ configuration. In this manner, the sensors 11 are coupled to the voltage dividing resistor 25 and the voltage generator 38. However, the embodiment of the sensor array 51 shown in FIG. 6 may be fabricated using only a single conductive layer, and therefore requiring only a single mask using conventional fabrication techniques.

During operation of the array shown in FIG. 6, the voltage generator 38 places a known voltage (10 volts in one embodiment however other voltages may be used) on all the sensors 11 in the array, but since all lines are in the dark state and shielded by the shields 44, except the line being activated only those sensors in the activated line are functional. The activated line is selected by the row selection integrated circuit 60. Under illumination the optical sensors 11 have significantly lower resistances (typically in the Gigaohm range, in one embodiment, or Megaohm range for typical optical transistor sensors) than the optical sensors 11 in the dark state (typically in the 1000s of gigaohms, in one embodiment). Accordingly, the current generated by voltage generator 28 passes mostly through the one optical sensor in the activated row.

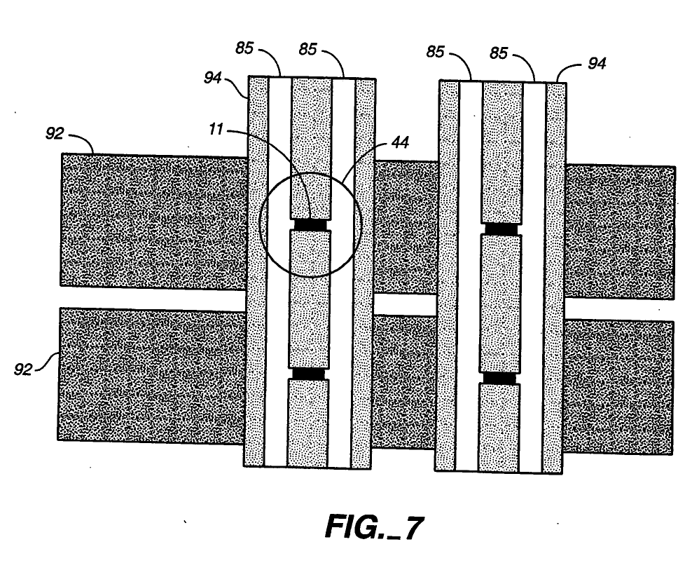

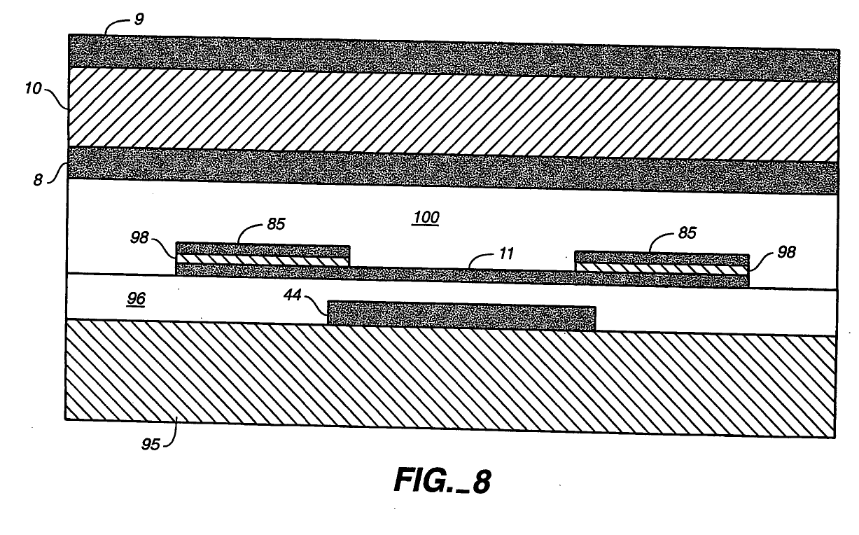

FIG. 7 illustrates pixel structure for four pixels of the array 51 shown in FIG. 6. The light source portion of the display is defined by cathode element 92, which is common ground. The cathode 92 in FIG. 7, in operation, would be electrically connected to the row selector 60, in the embodiment shown in FIG. 6. Row selector 60 selectively grounds the cathode of light emitter 10. The ungrounded cathodes in the other rows cause those rows to remain shut off. Cathode element 92 is typically formed of metallic elements and is opaque. It is advantageous that cathode element 92 be opaque, black in some embodiments, in order to maintain the dark state for the inactive sensors. In operation all cathode elements 92 are in the open condition, blocking any current flow. When a line is activated one cathode row is grounded, (see row selector 60, FIG. 3) enabling any OLED in that row to be turned on according to a positive voltage placed on the column anodes 94. Whether or not a voltage is applied to any particular column anode 94 depends on the display data, which determines which pixel is on or off. Not shown in FIG. 7 is a transparent dielectric, which electrically isolates anodes 94 from the sensors 11 and sensor electrical connector lines 85.

An exemplary process flow for forming the sensor array 51 shown in FIGS. 6 and 7 is described with reference to FIG. 8, showing a cross-section of the area marked 44 in FIG. 7. The process flow is exemplary only, and is not intended to limit embodiments of the invention to any of the specific equipment materials, or fabrication processes described. The sensor array is fabricated on a substrate 95. The substrate 95 is advantageously completely or partially transparent, and may be fabricated from generally any suitable material known in art—such as glass, quartz, oxides or plastics. Prior to fabrication of the sensor array, the substrate is optionally cleaned. Shield 44 is fabricated onto the substrate 95 using methods known in the art. In a preferred embodiment the shield 44 is screen-printed using opaque ink. The dimension of dark shield 44 is on the order of 0.001″ to 0.002″, in one embodiment though other dark shield dimensions larger or smaller may be implemented. Since dark shield 44 is opaque (or substantially opaque) it partially blocks the light emitted by OLED element. This is less than about 5% light blockage of the intended emission in a 100 dots per inch display.

Using typical semiconductor deposition equipment (in one embodiment a plasma enhanced chemical vapor deposition, PECVD, machine is used) dielectric layer 96 is deposited on the substrate 95, covering the shield 44. Dielectric layer 96 may be generally any suitable dielectric known in the art including silicon dioxide and silicon nitride. Light-sensitive material used in optical sensor 11 is then deposited. The light-sensitive material may include any of a variety of materials including amorphous silicon, cadmium selenide, poly silicon, cadmium sulfide and many more, as described above. Further, ohmic contact material 98 is deposited to assist in making electrical contact with the optical sensor 11. For example if amorphous silicon is used for optical element 11, ohmic contact material 98 could be phosphorous doped amorphous silicon. Finally, indium tin oxide (ITO) or other transparent conducting material is deposited to form sensor conductors 85. These thin films can be deposited in the same machine or in different machines, or in different facilities.

A photolithographic mask is generated as is well known in the art. The mask delineates the pattern for sensors 11 and conducting elements 58 in one continuous ladder-like pattern. The pattern is applied so that the dark shield is aligned and centered on the “rungs” of the conductor pattern. All layers are etched away using processes well known in the art, and suitable for the materials and thicknesses used. The result is that the sensor element 11 is buried under the phosphorous-doped layer and the ITO layer. Recall that only a single lithographic step has been used.

To separate the two conductor elements 85 and expose the mid-section of the sensor material 11, the ITO 85 and phosphorous-doped amorphous silicon 98 are etched away, without use of a further lithographic step. To accomplish this, substrate 51 is coated with negative photoresist as is well know in the art. All deposited layers are transparent except for dark shield 44, which is opaque. The photoresist is on top of the deposited layers. The photoresisted substrate is turned over and exposed from the backside. Since the photoresist is negative a hole in the resist is developed over the dark shield. Through this hole the shorting ITO layer is etched away using processes well known in the art followed by an etching process that removes the phosphorous doped material 98 used for the ohmic contact between the ITO electrical conducting elements 85, and amorphous silicon sensors 11.

The process above is advantageously used when the current conductor material is transparent. Such a material would include but not be limited to indium tin oxide (ITO). In the event an opaque current conductor is used including but not limited to chrome metal or aluminum metal, the follow process is preferred: After the sensor material is deposited as described above a coating of a positive photoresist is applied over the deposited sensor material. The wafer is flipped over and exposed from the back leaving photoresist over the opaque dark shields. The exposed sensor material is now etched away. The sensors are now isolated blocks of sensor material corresponding to the geometry of the dark shields. The next step is to apply a photolithographic mask having the reverse metal contact pattern. This produces what is known in the art as a lift mask. The contact metal is now deposited on top of the lift mask. Finally, the lift mask is removed from the wafer using processes well known in the art leaving the positive metal pattern to make contact with the sensors.

A final protection dielectric layer 100 that isolates the sensors 11 from the anodes of the OLED elements 10. This layer can be of polyimide material well known in the art, or it can be a deposited dielectric such as silicon dioxide or other insulative material compatible with the OLED structure yet to be deposed on top of the sensor array.

If the light sources 10 are being provided elsewhere, the fabrication ends here. However, in some embodiments, fabrication continues with the formation of OLED sources 10. Any OLED type material such the Kodak small molecule OLED, the Cambridge Display Technology (CDT) polymer LED (PLED), or the Universal Display Company's (UDC) phosphorescent LED (PHOLED) or any other type of OLED is deposited. The application of these materials to form the display is well known in the art and varies according to the type of OLED. In any case, the pixels in the OLED display are aligned with the sensor array so that the sensors 11 are centered to the pixel, thus aiding isolation of the sensors 11 in one column from affecting the sensors 11 in adjacent columns.

As described above, the sensors 11 are calibrated to determine the relationship between incident radiation level and measurable sensor parameter value. Referring to the sensor array embodiments in FIGS. 3 and 5, one embodiment of a procedure for calibrating the optical resistors 11 proceeds as follows. A uniform or substantially uniform light source adjustable to each level of brightness desired for the calibration is projected onto an area of the optical resistor array. The quality of the calibration is effected by the uniformity of the light source, so the light source should be as uniform as required by the desired accuracy level of the calibration. In one embodiment, a sensor array is calibrated by overlaying the optical array on a backlight such as used in LCD laptops. This would give the optical array the same uniformity of the backlight, which would be sufficient for laptop applications, but may not be sufficient for say, 4096, levels (12-bit) of grayscale. Such applications may use a light source of uniformity across the active area of at least about 0.025%. This high degree of light uniformity is available from amongst commercially available devices and method on the market.

Once the first level of the grayscale illuminates the optical array, the optical resistors 11 in the array are scanned one-by-one (or according to some other scheme) at a known voltage supplied by voltage source and/or current from which the resistance of the optical resistor is easily calculated. These resistance values are stored in memory using a data collection circuit. The array is again scanned with the illumination turned up to the next value and the resistance values and again stored. This operation is repeated until the full grayscale from the darkest to the brightest has been completed. In some embodiments, only one value may be stored. In other embodiments, 5 resistance values are stored. In other embodiments 4096 values are stored. In other embodiments other numbers of resistance values may be stored. In generally any number of resistance values from one up to the number of discernable gray scale, brightness, or color values may be used and furthermore (though having little practical benefit) even more resistance values than the number of discernable gray scale, brightness, or color values may be used. The resultant values are stored in a look-up table or other memory data structure. Values not specifically stored in the look-up table may be interpolated from one or more stored values. Each optical array manufactured may be serialized and the look-up data stored on a website in association with the serialized number. Other association schemes may be used to communicate the look-up table for each sensor array—including bar codes, memory stored on or with the array, transmitting the look-up table to a receiver located in communication with the array, and still other embodiments provide the data in other ways. When the optical array is mated with, matched to, or otherwise identified with a display the look-up table data is downloaded from the website (or other source) to the memory chip to be used with the display, for example.

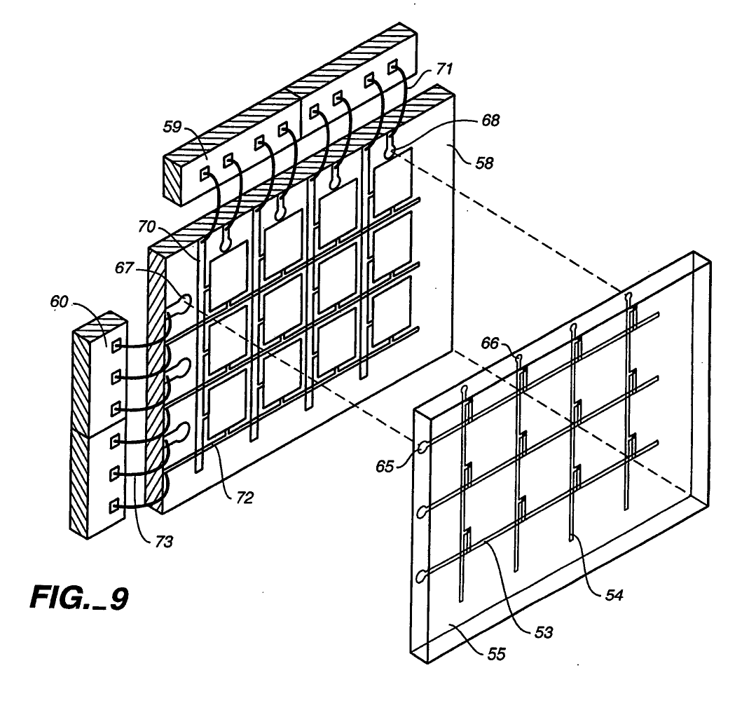

Displays using sensor arrays as described with regard to FIGS. 3 and 5 may be assembled in a variety of ways. In one embodiment of the invention the row- and column-addressable array of sensors 11 is formed on a transparent substrate 55, such as glass, polymer, or other transparent substrate as illustrated in FIG. 9. The sensor element array consists of vertical parallel conducting lines 54 equal to the number of columns in the passive emissive display and horizontal conduction lines 53 equal to the number of rows in the display. At the junction of vertical and horizontal conduction lines is deposed sensors 11, as also shown in FIGS. 3 and 5.

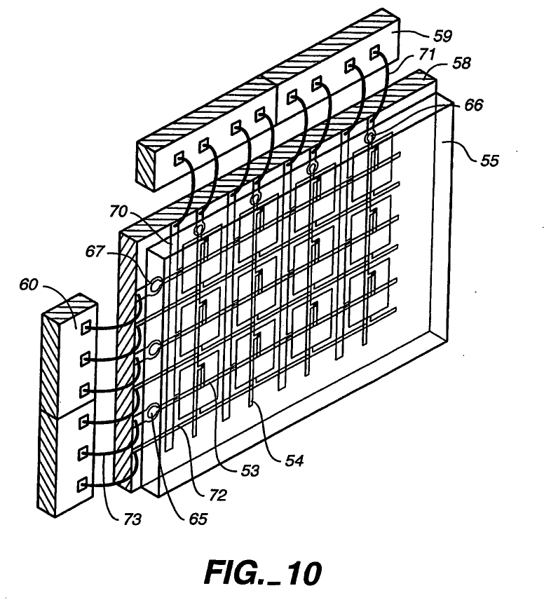

FIG. 9 shows an exploded drawing of an array of light sources 58 coupled to a column integrated circuit (IC) 59, which may include the circuitry indicated in FIGS. 3 and 5. The column IC 59 is operable to apply image data to and receive sensor data from sensors and light sources in each column. The light source array 58 is further coupled to a row selector 60, which may contain the circuitry indicated in FIGS. 3 and 5. The row selector is operable to select a row for writing image data and/or reading sensor parameter values. The light source array 58 is positioned to illuminate the sensor array 55. Dotted lines in FIG. 9 indicate the electrical contact pads 66 and 65 on optical resistor array 55 may be aligned with electrical contact pads 67 and 68 on display 58. In FIG. 10 optical resistor array 55 is in contact with display 58. In one embodiment, column electrical lines 70 and 54 are connected to column IC 59 with wire bonds 71, and row electrical lines 53 and 72 are connected to row selector 60 through wire bonds 73. In another embodiment of the invention each sensor array 55 and display 58 could have separate cables attached to them that would connect to a printed circuit board (PCB), which also had row selector 60 and column IC 59 attached. Other connection means and methods as are known in the art may also or alternatively be used.

In one embodiment, the time it would take to scan 1000 levels of gray would be about 10 seconds at 100 frames per second. This procedure will give an optical response curve for each element in the optical array. There would be no need to have a gamma correction system in the display. Variance in optical response in the semiconductor used for the optical resistor would be accounted for. Different wavelength light sources, such as red, green, and blue light sources, may be calibrated separately.

The methods and apparatuses according to embodiments of the present invention find use in a variety of applications. Preferred embodiments of displays may be utilized in automotive applications, such as navigation or audio/visual displays, tuner displays, odometer and speedometer displays. Other applications include television display screens (particularly large TV display screens such as those having a picture diagonal larger than 30 inches), computer monitors, large screen scientific information or data displays, cellular phones, personal data assistants, and the like.

From the foregoing it will be appreciated that, although specific embodiments of the invention have been described herein for purposes of illustration, various modifications may be made without deviating from the spirit and scope of the invention. Accordingly, the invention is not limited except as by the appended claims.

What is claimed is:

1. A method for controlling emission from a pixel using a pixel driver and a sensor having a measurable sensor parameter to achieve a predetermined emission level, the method comprising:
varying light emission from the pixel using the pixel driver;
receiving light emission from the pixel at the sensor;
obtaining a measured value of the measurable sensor parameter responsive to the received light emission;
coupling the measured value to the pixel driver; and
generating a control signal for the pixel to maintain constant emission from the light source at the predetermined emission level.

2. A method according to claim 1, wherein the pixel includes a light source.

3. A method according to claim 1, wherein the pixel driver provides a voltage to the pixel.

4. A method according to claim 1, wherein the pixel driver is not contained within the pixel.

5. A method according to claim 1, wherein the pixel is a pixel of a liquid crystal display.

6. A method according to claim 2, wherein the light source includes a light emitting diode.

7. A method according to claim 2, wherein the light source includes a white light emitting diode.

8. A method according to claim 2, wherein the light source includes an organic light emitting diode.

9. A method according to claim 1, wherein the sensor includes a light-sensitive resistor, optical diode, or optical transistor.

10. A method according to claim 1, wherein the sensor includes a light-sensitive resistor and the measurable sensor parameter includes a voltage across the resistor.

11. A method according to claim 1, further comprising comparing the measured value to a reference value of the measurable sensor parameter, the reference value indicative of the predetermined emission level.

12. A method according to claim 11, wherein the reference value is an image voltage.

13. A method according to claim 11, further comprising calibrating the sensor to determine the reference value.

14. A method according to claim 13, wherein the act of calibrating the sensor comprises illuminating the sensor with a calibration light source.

15. A method according to claim 2, wherein the light source is a pixel of a display.

16. A method according to claim 1, wherein the light source is an organic light emitting diode and the act of generating a control signal includes increasing a current through the light emitting diode.

17. A method according to claim 11, wherein the act of comparing the measured value with the reference value includes coupling the measured value and the predetermined value to a comparator.

18. A method according to claim 1, wherein the pixel driver provides a varying signal to the pixel to cause increasing light emission from the pixel and wherein the act of generating a control signal comprises replacing the varying signal with a constant signal to cause stable light emission from the light source.

19. A method according to claim 18 wherein the varying signal comprises a ramp signal.

20. A method according to claim 19, wherein the ramp signal comprises a voltage ramp.

21. An apparatus for controlling emission from a pixel to achieve a predetermined emission level, the apparatus comprising:
a sensor having a measurable sensor parameter positioned to receive at least a portion of the radiation emitted from the pixel;
a pixel driver coupleable to the pixel for varying the light emission from the pixel; and
a control unit coupled to the sensor and operable to couple a control signal to the pixel driver to maintain constant emission from the pixel when the predetermined emission level is attained.

22. An apparatus according to claim 21, the control unit further coupled to a reference signal indicative of the value of the measurable sensor parameter during the predetermined emission level, the control unit operable to compare the reference signal and the measured value.

23. An apparatus according to claim 21 further comprising a calibration look-up table coupled to the control unit, the calibration look-up table storing at least one value of the measurable sensor parameter indicative of the predetermined emission level.

24. A controlled pixel system, the system comprising:
a pixel element;
a sensor having a measurable sensor parameter positioned to receive at least a portion of the radiation emitted from the pixel;
a pixel driver coupled to the pixel, the pixel driver operable to supply a drive signal to the pixel to vary light emission from the pixel; and
a control unit coupled to the pixel driver and the sensor, the control unit operable to determine, based on a measured value of the measurable sensor parameter, the predetermined emission level is attained and develop a control signal for the pixel driver to maintain constant light emission at the predetermined emission level.

25. A controlled pixel system according to claim 24, wherein the pixel element is formed in a first area and the pixel driver is outside the first area.

26. A controlled pixel system according to claim 24, wherein the pixel driver provides a varying signal to the pixel.

27. A controlled pixel system according to claim 24, wherein said control unit is further coupled to a reference signal indicative of the predetermined emission level, the control unit further operable to compare the measured value of the measurable sensor parameter with the reference signal to determine the predetermined emission level is attained.

28. A controlled pixel system according to claim 24, wherein said sensor includes a photo-sensitive resistor, diode, or transistor.

29. A controlled pixel system according to claim 24, further comprising a plurality of pixel elements.

30. A method of controlling an array of pixels in an active matrix display to a predetermined emission level, the pixels arranged in a plurality of rows and a plurality of columns, each pixel having an active matrix element, the method using a plurality of sensors each having a measurable sensor parameter and at least one pixel driver, the method comprising:
varying light emission from a plurality of pixels in a first row using the at least one pixel driver and the active matrix elements;
receiving light emission from the plurality of pixels at the plurality of sensors;
obtaining a measured value of the measurable sensor parameter for each of the plurality of sensors responsive to the received light emission; and
for each of the plurality of pixels, generating a control signal for the pixel to maintain constant emission from the light source at the predetermined emission level.

31. A method according to claim 30, wherein each of the plurality of pixels include a light source.

32. A method according to claim 30, wherein the at least one pixel driver provides a voltage to each of the plurality of pixels.

33. A method according to claim 30, wherein the plurality of pixels are pixels of a liquid crystal display.

34. A method according to claim 31, wherein the light source includes a light emitting diode.

35. A method according to claim 31, wherein the light source includes a white light emitting diode.

36. A method according to claim 31, wherein the light source includes an organic light emitting diode, electroluminescence, plasma emission, field emission, or vacuum florescence.

37. A method according to claim 30, wherein each of the plurality of sensors include a light-sensitive resistor, optical diode, or optical transistor.

38. A method according to claim 30, wherein at least one of the plurality of sensors includes a light-sensitive resistor and the measurable sensor parameter includes a voltage across the resistor.

39. A method according to claim 30, further comprising comparing the measured value to a reference value of the measurable sensor parameter, the reference value indicative of the predetermined emission level.

40. A method according to claim 39, wherein the reference value is an image voltage.

41. A method according to claim 40, further comprising calibrating the sensor to determine the reference value.

42. A method according to claim 41, wherein the act of calibrating the sensor comprises illuminating the sensor with a calibration light source.

43. A method according to claim 31, wherein the light source is an organic light emitting diode and the act of generating a control signal includes increasing a current through the light emitting diode.

44. A method according to claim 39, wherein the act of comparing the measured value with the reference value includes coupling the measured value and the predetermined value to a comparator.

45. A method according to claim 30, wherein the pixel driver provides a varying signal to the pixel to cause increasing light emission from the pixel and wherein the act of generating a control signal comprises replacing the varying signal with a constant signal to cause stable light emission from the pixel.

46. A method according to claim 45, wherein the varying signal comprises a ramp signal.

47. A method according to claim 46, wherein the ramp signal comprises a voltage ramp.

48. A method according to claim 46, wherein the ramp signal comprises a step voltage

49. A method according to claim 30, further comprising: receiving image data including a desired emission level for the plurality of pixels in a first row, the image data including a target value for the measurable sensor parameter.

50. A method according to claim 49, further comprising comparing the value of the measurable sensor parameter of each sensor with the image data.

51. A method according to claim 30, further comprising repeating the acts of varying, receiving, obtaining and generating for a plurality of pixels in a second row.

52. An apparatus for controlling an active matrix display including an array of pixels arranged in a plurality of rows and a plurality of columns, each pixel element including an active matrix element, the apparatus comprising:
a sensor array arranged in a plurality of rows and a plurality of columns, each sensor having a measurable sensor parameter and positioned to receive at least a portion of the radiation emitted from at least one of the pixels;
a row selector coupled to the sensor array and coupleable to the display operable to select at least one of the plurality of rows; and
a plurality of control units, each coupled to a plurality of the sensors located in a common column and a reference signal indicative of a target value of the measurable sensor parameter for a pixel in the selected row, the control unit operable to compare a measured value of the sensor parameter with the reference signal and generate a control signal, the control unit further coupled to the active matrix elements such that the active matrix elements receive the control signal and maintain the amount of radiation emitted from the light source.

53. An apparatus according to claim 52, the plurality of control units each further coupled to a reference signal indicative of the value of the measurable sensor parameter during the predetermined emission level for each of the pixels in the selected row, the control unit operable to compare the reference signal and the measured value.

54. An apparatus according to claim 52 further comprising a calibration look-up table coupled to the control units, the calibration look-up table storing at least one value of the measurable sensor parameter indicative of the predetermined emission level.

55. An apparatus according to claim 54 further comprising a line buffer coupled to the look-up table and the control units.

56. A controlled active matrix display, comprising:
an array of pixels arranged in a plurality of rows and a plurality of columns, each pixel element including an active pixel element configured to drive the pixel;
a sensor array arranged in the plurality of rows and the plurality of columns, each sensor having a measurable sensor parameter and positioned to receive at least a portion of the radiation emitted from at least one of the pixels;
a row selector coupled to the sensor array and the array of pixels and operable to select at least one of the plurality of rows;
a plurality of control units, each coupled to a plurality of the sensors located in a common column and a reference signal indicative of a target value of the measurable sensor parameter for a pixel in the selected row, the control unit operable to compare a measured value of the sensor parameter with the reference signal and generate a control signal; and
a pixel driver coupled to the active matrix elements, the pixel driver coupled to the active matrix elements and operable to vary an amount of radiation emitted from at least one pixel, the active matrix elements operable to receive the control signal and maintain the amount of radiation emitted from the pixel.

57. A controlled active matrix display according to claim 56, wherein the pixel driver provides a varying signal to the active matrix elements.

58. A controlled active matrix display according to claim 56, wherein the control units are further coupled to a reference signal indicative of a predetermined emission level, the control unit further operable to compare the measured value of the measurable sensor parameter with the reference signal to determine the predetermined emission level is attained.

59. A controlled active matrix display according to claim 56, wherein said sensor includes a photo-sensitive resistor, diode, or transistor.

60. A method of controlling light emission to a predetermined emission level in a passive matrix display having an array of pixel elements arranged in a plurality of rows and a plurality of columns, the method using a plurality of sensors having a measurable sensor parameter and a pixel driver, the method comprising:
varying light emission from a plurality of pixels in a first row using the pixel driver;
monitoring light emission from the plurality of pixels in the first row by monitoring an actual value of the measurable sensor parameter of each of a plurality of sensors, each of the plurality of sensors positioned to receive at least a portion of the light emission from one of the plurality of pixels in the first row;
coupling the actual value of the measurable sensor parameter of each of the plurality of pixels to the pixel driver; and
generating a control signal for the plurality of pixels to maintain constant emission from at the predetermined emission level.

61. A method according to claim 60, wherein each of the plurality of pixels include a light source.

62. A method according to claim 60, wherein the pixel driver provides a voltage to each of the plurality of pixels.

63. A method according to claim 60, wherein the pixel driver is not contained within any of the plurality of pixels.

64. A method according to claim 60, wherein the plurality of pixels are pixels of a liquid crystal display.

65. A method according to claim 61, wherein the light source includes a light emitting diode.

66. A method according to claim 61, wherein the light source includes a white light emitting diode.

67. A method according to claim 61, wherein the light source includes an organic light emitting diode.

68. A method according to claim 60, wherein each of the plurality of sensors include a light-sensitive resistor, optical diode, or optical transistor.

69. A method according to claim 60, wherein each of the plurality of sensors include a light-sensitive resistor and the measurable sensor parameter includes a voltage across the resistor.

70. A method according to claim 60, further comprising comparing the actual value to a reference value of the measurable sensor parameter, the reference value indicative of the predetermined emission level.

71. A method according to claim 70, wherein the reference value is an image voltage.

72. A method according to claim 70, further comprising calibrating the plurality of sensors to determine the reference value for each of the plurality of sensors.

73. A method according to claim 72, wherein the act of calibrating the sensor comprises illuminating the sensor with a calibration light source.

74. A method according to claim 61, wherein the light source is an organic light emitting diode and the act of generating a control signal includes increasing a current through the light emitting diode.

75. A method according to claim 60, wherein the act of comparing the measured value with the reference value includes coupling the measured value and the predetermined value to a comparator.

76. A method according to claim 60, wherein the pixel driver provides a varying signal to each of the plurality of pixels in the first row to cause increasing light emission from the pixel and wherein the act of generating a control signal comprises replacing the varying signal with a constant signal to cause stable light emission from each of the plurality of pixels in the first row.

77. A method according to claim 76, wherein the varying signal comprises a ramp signal.

78. A method according to claim 77, wherein the ramp signal comprises a voltage ramp.

79. A method according to claim 60, further comprising repeating the acts of varying, monitoring, coupling and generating for a plurality of light sources in a second row.

80. An apparatus for controlling a passive matrix display including an array of pixels arranged in a plurality of rows and a plurality of columns, the apparatus comprising:
a sensor array arranged in a plurality of rows and a plurality of columns, each sensor having a measurable sensor parameter and positioned to receive at least a portion of the radiation emitted from at least one of the pixels;
a row selector coupled to the sensor array and coupleable to the display operable to select at least one of the plurality of rows;
a plurality of comparators, each coupled to a plurality of the sensors located in a common column and a reference signal indicative of a target value of the measurable sensor parameter for a pixel in the selected row, the comparator operable to compare a measured value of the sensor parameter with the reference signal and generate a control signal; and
a plurality of pixel drivers, each coupled to pixels located in a common column, each of the plurality of pixel rivers coupled to a selected one of the plurality of comparators and operable to receive the control signal and maintain the amount of radiation emitted from the pixels.

81. An apparatus according to claim 80 further comprising a calibration look-up table coupled to at least one of the plurality of comparators, the calibration look-up table storing at least one value of the measurable sensor parameter indicative of the predetermined emission level.

82. A controlled passive matrix display comprising:
an array of pixels arranged in a plurality of rows and a plurality of columns;
a sensor array arranged in a plurality of rows and a plurality of columns, each sensor having a measurable sensor parameter and positioned to receive at least a portion of the radiation emitted from at least one of the pixels;
a row selector coupled to the sensor array and the array of light sources and operable to select at least one of the plurality of rows;
a plurality of comparators, each coupled to a plurality of the sensors located in a common column and a reference signal indicative of a target value of the measurable sensor parameter for a pixel in the selected row, the comparator operable to compare a measured value of the sensor parameter with the reference signal and generate a control signal; and
a plurality of pixel drivers coupled to the plurality of comparators, each pixel driver further coupled to the pixels in a common column, the pixel drivers operable to vary the amount of light emitted from the light source and, responsive to the control signal, to maintain the amount of light emitted from the pixel.

83. A controlled passive matrix display according to claim 82 wherein the pixel driver provides a varying signal to the pixels.

84. A controlled pixel system according to claim 82, the comparator further operable to compare the measured value of the measurable sensor parameter with the reference signal to determine the predetermined emission level is attained.

85. A controlled pixel system according to claim 82 wherein said sensor array includes a photo-sensitive resistor, diode, or transistor.

86. A method for aligning a dark shield with a sensor and a plurality of contacts, the method comprising:
forming the dark shield on a first surface of a transparent substrate having a second surface opposite the first surface;
depositing an insulating material over the dark shield;
depositing material for the sensor over the insulating material and the dark shield;
depositing material for the electrical contacts over the material for the sensor;
coating the substrate with negative photoresist above the material for the electrical contacts;
exposing the negative photoresist with a light source positioned to pass light through the transparent substrate, such that a portion of the light is blocked by the dark shield;
developing the negative photoresist; and
etching the material for the electrical contacts through the developed negative photoresist, such that a plurality of electrical contacts are formed over the material for the sensor, and the plurality of electrical contacts are aligned with the dark shield.

87. A method for aligning a dark shield with a sensor and a plurality of contacts, the method comprising:
forming the dark shield on a first surface of a transparent substrate having a second surface opposite the first surface;
depositing an insulating material over the dark shield;
depositing material for the sensor over the insulating material and the dark shield;
coating the substrate with positive photoresist above the sensor material;
exposing the positive photoresist with a light source positioned to pass light through the transparent substrate, such that a portion of the light is blocked by the dark shield;
developing the positive photoresist;
etching the sensor material to conform to the dark shield;
depositing contact metal over the sensor material; and
etching contact metal such that a plurality of electrical contacts are formed over and aligned to the material for the plurality of sensors.
